(19) United States
(12) Patent Application Publication
(10) Pub. No.: US 2014/0366921 A1
(43) Pub. Date: Dec. 18, 2014

(54) CONTROL UNIT FOR A COOKING DEVICE

(71) Applicant: HANNING ELEKTRO-WERKE GMBH & CO. KG, OERLINGHAUSEN (DE)

(72) Inventors: Jochen Schneider, Oerlinghausen (DE); Julian Peter, Oerlinghausen (DE)

(21) Appl. No.: 14/219,750

(22) Filed: Mar. 19, 2014

(30) Foreign Application Priority Data
Mar. 19, 2013 (DE) 10 2013 004 660.2
Oct. 2, 2013 (DE) 10 2013 110 975.6

(51) Int. Cl. F24C 14/00; H02P 5/74; A47L 25/00

(52) U.S. Cl. CPC F24C 14/005; A47L 25/00; H02P 5/74
USPC 134/57 R; 134/58 R; 318/51

(57) ABSTRACT

Cleaning apparatus for kitchen equipment, in particular combination steaming, baking and cooking equipment, has a cooking space that is to be cleaned which is delimited by at least one wall and includes at least one outlet opening for a liquid. The apparatus comprises a ventilation fan associated with the cooking space having a drive motor; a collecting tank, which at least temporarily collects the liquid that exits the cooking space via the outlet opening; an inlet line that can be connected to a water reservoir and can be selectively opened and closed to supply a liquid; a circulating pump for pumping liquid, having a circulating pump wheel and a circulating pomp motor driving the circulating pump motor, a circulation line by which the liquid conveyed by the circulating pump can be supplied to the cooking space that is to be cleaned; a drain line connected to the collecting tank for removing the liquid received from the collecting tank; and a control unit for operating the drive motor and the circulating pump motor. The control unit has a distributed power electronics having a first inverted rectifier for the drive motor of the ventilation fan, a second inverted rectifier for the circulating pump motor and a supply unit for the inverted rectifiers which is connectable to a power source, said supply unit comprising a rectifier, an interim circuit and a power factor correction filter.

The invention relates to a cleaning apparatus for kitchen equipment, in particular combination steamer, baking and/or cooking equipment having a cooking space to be cleaned that is delimited by at least one wall. The cooking space has at least one outlet opening for a liquid, a ventilation fan with a drive motor, and a collecting tank which at least temporarily collects the liquid that exits the cooking space via the outlet opening. An inlet line, connected to a water reservoir, which can be selectively opened or closed to supply liquid, has a circulating pump for pumping the liquid. The circulating pump has a circulating pump wheel and a circulating pump motor driving the circulating pump wheel. A circulation line is provided to convey the liquid from the circulating pump to the cooking space to be cleaned and a drain is connected to the collecting tank line for removing the liquid received from the collecting tank. Finally, the cleaning apparatus has a control unit for operating the drive motor and the circulating pump motor.

Typically, control of ventilation and pump motors of combination steamer, cooking equipment and similar oven systems is carried out separately via separate electronic components. Each motor is provided with a single power electronics that is housed centrally at the motor. While the pump motors do without converters, the ventilation motor comprises power electronics in which the supply unit with a rectifier, interim circuit and power factor correction filter, on the one hand, and an inverted rectifier on the other hand, are fractionally and spatially integrated.

### SUMMARY OF THE INVENTION

The principal objective of the present invention is to simplify and design a cost-efficient control unit for kitchen equipment of the type described above.

This objective, as well as other objectives which will become apparent from the discussion that follows, are achieved, in accordance with me present invention, by providing a control device with a distributed power electronics having a first inverted rectifier for the drive motor of the ventilation fan and having a second inverted rectifier for the circulating pump motor, as well as a supply unit comprising a rectifier, an interim circuit and a power factor correction filter that are provided jointly for the inverted rectifiers and that can be connected to a power source (i.e., a power utility).

The particular advantage of the invention is that due to the use of a common supply unit, which is provided decentralized relative to the motors cost advantages will arise and at the same time the space requirements will be lowered. The decentralized accommodation of the power electronics as a whole or of the power supply unit allows for the motors to operate at high ambient temperatures, while the supply unit and potentially also the inverted rectifiers are preferably housed and operated spatially separated in an installation space at a lower ambient temperature. Thus, components with lower temperature resistance and greater cost-effectiveness can be used for this purpose. Also, the existing space can be utilized optimally through the separate arrangement of motors, inverted rectifiers and power supply unit, because a plurality of small components is easier to accommodate in the space available in the device than a large unit. Furthermore, by using an inverted rectifier for the circulating pump motor, the motor can be implemented in the manner of a brushless DC motor and can be controlled or driven with variable speeds. This raises the efficiency.

According to one preferred embodiment of the invention, a drain pump is provided having a drain pump wheel and a drain pump motor which drives the drain pump wheel. The drain pump is used to pump off the liquid exiting from the cooking space via the drain line. A third inverted rectifier is hereby provided as part of the power electronics for the drain pump motor, wherein the third inverted rectifier interacts with the common supply unit. In this case the supply unit feeds all three inverted rectifiers. Advantageously, the drain pump can be controlled cost-efficiently by using the already provided distributed power electronics. The supply unit of the power electronics with the inverter, the interim circuit and the power factor correction filter are thus used for supplying or controlling the ventilation motor, the circulating pump motor and the drain pump motor. This results in a high degree of integration and a reduction of the assembly and installation expenditures.

For example, the entire power electronics can be designed as a spatial unit and provided at a distance from the motor. The inverted rectifiers are then realized directly adjacent to the supply unit with the common rectifier, interim circuit and power factor correction filter. According to the invention, the power electronics can also provide a decentralized supply unit that feeds the inverted rectifiers that are provided in the system for the motors. The inverted rectifiers themselves can be provided spatially adjacent to the motors and can be arranged in the area of a bearing shield of the motors, for example. The resultant advantage is that electromagnetic interferences stemming from the motor line are reduced in the device.

For example, the power electronics as a whole or the supply unit can be provided on a main control board of the kitchen equipment. The main control unit for the kitchen equipment is provided or installed regularly at a location, where no impermissible or critical temperatures are present. The functional or spatial integration of the power electronics or of the power supply unit in the main control unit can be beneficial from the construction space and cost perspective and may simplify the installation.

A further development of the invention provides for a central control unit that operates in conjunction with the inverted rectifiers of the decentralized power electronics. Providing the central control unit ensures that the motors are operated independent of each other and are integrated into a single overall control process. There is also the ability for a modular extension of the system when using the central control unit. For example, more actuator components can be controlled through the already provided control unit. Also, a heater or sensors can work in conjunction with the central control unit or can be operated by it. The central control unit can be spatially or functionally integrated with the supply unit or the power electronics, for example on the main control board.

In particular, the control topology can provide a data bus to connect the central control unit to the inverted rectifiers of the distributed power electronics. This simplifies the design of the overall system and thus lowers installation effort and costs. The data bus is preferably implemented as a serial data bus. When using brushless DC motors, the speed specification can be realized via the data bus, for example.

It is provided, for example, that the pump motors (circulating pump motor, drain pump motor) powered by the distributed power electronics are driven in coordinated fashion by the central control unit. According to one particular form of implementation of the invention, the cleaning apparatus includes the collecting tank as the common liquid reservoir that has both the drain pump and the circulating pump associated with it. The central control unit is implemented such that liquid is pumped from the collecting tank using the circulating pump and is provided to the cooking space for cleaning the cooking space. In particular, the pump-circulated liquid can be sprayed onto the running ventilation fan and can be atomized or distributed, respectively. In this respect, the circulating pump and the ventilation motor are, at least temporarily, driven jointly and at the same time during the cleaning process. For example, the drain pump can be operated after the cleaning process to pump away the liquid and the dirt particles, greases and the like contained therein that have collected in the collecting tank. In this case, the drain pump motor is operated separately and with a time offset relative to the circulating pump motor. In this situation, the supply occurs from the distributed power electronics together with the supply unit and the inverted rectifier that is associated with the drain pump motor. The control is carried out via a central control unit.

Additional advantages, features and details of the invention become apparent from the following description. Features mentioned here can be essential to the invention both individually or in any combination. The drawings serve only as examples to clarity the invention and are not restrictive in nature.

For For a full understanding of the present invention, reference should now be made to the following detailed description of the preferred embodiments of the invention as illustrated in the accompanying drawings.

### BRIEF DESCRIPTION OF THE DRAWINGS

FIG. 1 is a diagram showing a first embodiment of the cleaning apparatus for kitchen equipment according to the present invention.

FIG. 2 is a diagram showing a second embodiment of the cleaning apparatus for kitchen equipment according to the present invention.

### DETAILED DESCRIPTION OF THE PREFERRED EMBODIMENTS

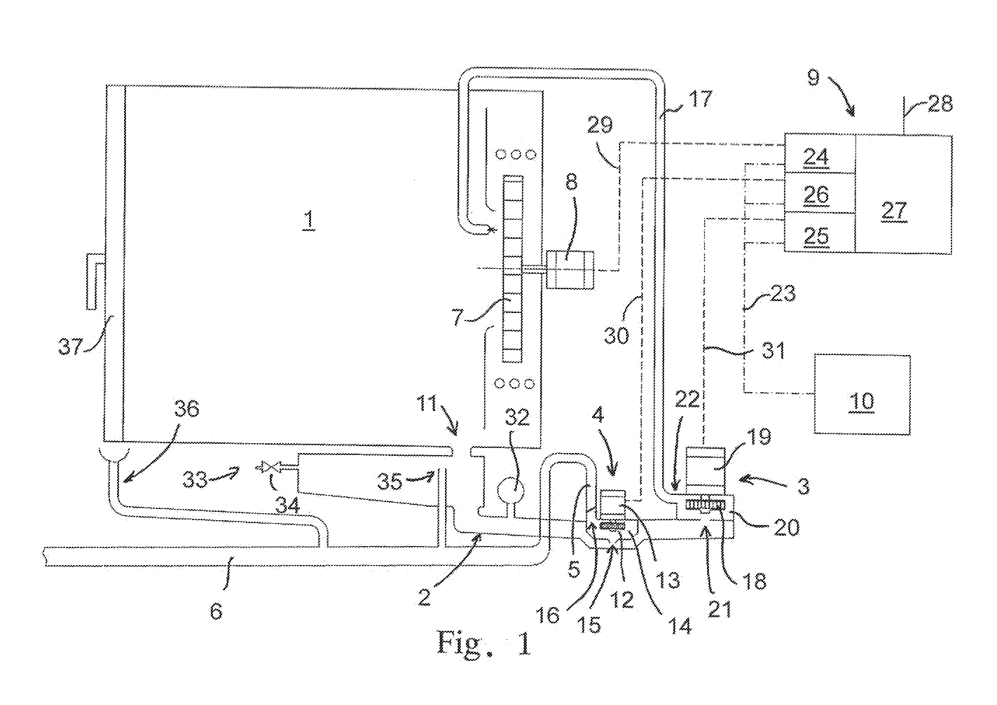

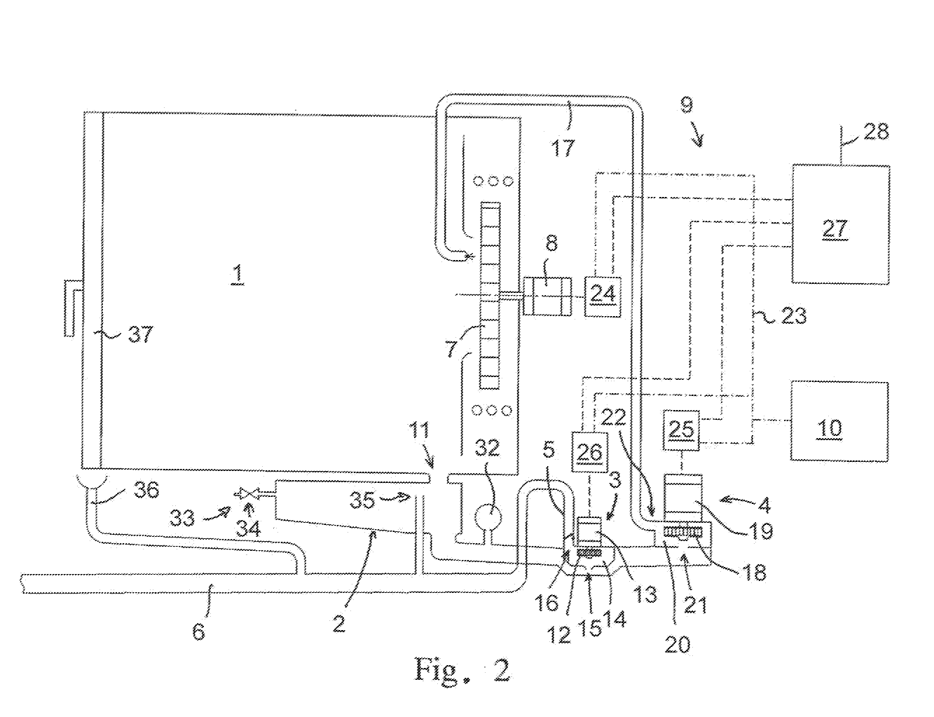

The preferred embodiments of the present invention will now be described with reference to FIGS. 1 and 2 of the drawings. Identical elements in the two figures are designated with the same reference numerals

FIG. 1 shows a cleaning apparatus for kitchen equipment that has a cooking space 1 that is to be cleaned, with a collecting tank 2 that in the shown installation position of the cooking equipment is arranged below the cooking space 1, that has a circulating pump 3 for emulating liquid stored in the collecting tank 2 and arranged at the collecting tank 2, that has a drain pump 4 for pumping away the liquid coming from the collecting tank 2 via a riser 5 of the cleaning apparatus into a drain line 6 thereof and also arranged at the collecting tank 2, and having a ventilation fan 7 arranged at the cooking space 1, that has a drive motor 8 for the ventilation fan 7 as well as a control device for powering the drive motor 8, the circulating pump 3 and the drain pump 4. As essential components, the control device comprises a distributed power electronics 9 as well as a central control unit 10. The cleaning apparatus is used for the preferably automated self-cleaning of the cooking equipment after use.

To ensure that the food remains juicy and does not dry out during food preparation in the shown cooking equipment, a not shown steam generator, or by directly injecting water of another liquid into the cooking space 1 is employed. Excess water arises in this process through condensation and is discharged from the cooking space. The liquid exiting the cooking space arrives in the collecting tank 2 via an outlet opening 11 that is provided in the lower area of the cooking space 1. Depending on the material to be cooked, grease or other liquid substances may also need to be discharged from the cooking space together with the liquid. Furthermore, solids such as lime, when using hard water, can be formed by the condensing water. These solids must also be removed from the cooking space 1 and arrive in the collecting tank 2.

The liquids and solids collected in the collecting tank 2 can he conveyed and removed via the riser 5 into the drain line 6 using the drain pump 4. Here, the drain pump 4 is provided in a lower area of the collecting tank 2, relative to its installation position. A drain pump wheel 12 of the drain pump 4 that is powered by a drain pump motor 13 is positioned in a conveyor space 14 provided in the collecting tank 2 as a part thereof such that the liquid to be removed enters into the conveyor space 14 via an inlet opening 15. On the pressure side, the liquid to he removed is transported via an outlet opening 16 from the conveyor space 14 into the riser 5 and further into the drain line 6.

Modern kitchen equipment typically has a self-cleaning mechanism. The circulating pump 3 and a circulating line 17 are provided as part of the self-cleaning mechanism. The liquid conveyed by the circulating pump 3 is provided via the circulation line 17 to the cooking space 1 that is to be cleaned. Similar to the drain pump 4, the circulating pump 3, having a circulating pump wheel 18 and a circulating pump motor 19 for driving the circulating pump wheel 18 is provided at the collecting tank 2. The circulating pump wheel 18 is associated with an additional conveyor space 20, wherein the conveyor space 14 is also implemented as part of the collecting tank 2. The circulating liquid arrives in the conveyor space 20 via an inlet opening 21. On the pressure side, the liquid to be circulated is conveyed into the circulating line 17 via an outlet opening 22 aid from there is supplied to cooking space 1.

The control unit 10 of the control device is designed as a central control unit 10. It communicates with the three inverted rectifiers 24, 25, 26 via a serial data bus 23. The inverted rectifiers 24, 25, 26 are realized as part of the power electronics 9 and supply the drive motor 8 of the ventilation fan 7, the circulating pump motor 19 as well as the drain pump motor 13. The power electronics furthermore comprises a common supply unit 27 that feeds the inverted rectifiers 24, 25, 26 and comprises a rectifier, an interim circuit and a power factor correction filter (PFC). The supply unit 27 is connected to a supply net (not shown) via a supply line 28. In this case, the supply unit 27 is realized as a mains input unit. It is operated at a mains voltage and supplies the connected inverted rectifiers 24, 25, 26 with the intended interim circuit voltage. The inverted rectifiers 24, 25, 26 are located directly adjacent to the supply unit 27 of the power electronics 9 and are provided de-centrally and distant from the motors 8, 13, 19. The inverted rectifiers 24, 25, 26 are connected to motors 8, 13, 19 via motor lines 29, 30, 31.

The central control unit 10 controls the inverted rectifiers 24, 25, 26 of the drive motor 8, the drain pump motor 13 and the circulating pump motor 19 via data bus 23 separately and according to need such that the drive motor 8 can be operated independent of the pumps 3, 4 while the food is being prepared. During self-cleaning, the circulating pump 3 and possibly the drive motor 8 can also be controlled as needed and separately. There is also the option of operating the drain pump 4 for removing the liquid sitting in the collecting tank 2, for example after carrying out the self-cleaning, independent of the other motors 8, 19.

The decentralized arrangement of the power electronics 9 allows for the motors 8, 13, 19 to operate at high ambient temperatures of, for example, 70° C., by providing the supply unit 27 and if needed also the inverted rectifiers 24, 25, 26 in a cool installation space of the cooking equipment. In addition, by using the supply unit 27 jointly for the three inverted rectifiers 24, 25, 26, synergies are developed and costs reduced. Providing inverted-rectifier-controlled pump motors 13, 19 allows for speed-variable operation of the motors 13, 19 and increases the efficiency of the entire system. The pump motors 13, 19 are preferably realized as so-called BLDC motors or brushless DC motors.

According to a second preferred embodiment of the invention according to FIG. 2, the inverted rectifiers 24, 25, 26 of the power electronics 9 are arranged in distributed fashion. The first inverted rectifier 24, which is provided for the speed-variable drive of the drive motor 8, is provided directly at the drive motor 8 of the ventilation fan 7. The inverted rectifier 24 can be arranged at a bearing shield of drive motor 8, for example. Similarly, the second inverted rectifier 25 is provided at the drain pump motor 13 and the third inverted rectifier 26 at the circulating pump motor 19. Here too the inverted rectifiers 25, 26 can be arranged in the area of a hearing shield of the motors 13, 19. Furthermore, the decentralized supply unit 27 of the power electronics 9 feeds the inverted rectifiers 24, 25, 26 and supplies them with the required interim circuit voltage. The supply unit 27 is preferably housed in a cooler installation space of the cooking equipment. The serial data bus 23 connects the central control unit 10 and the inverted rectifiers 24, 25, 26. Advantageously, providing the inverted rectifiers 24, 25, 26 at the motors 8, 13, 19 reduces electromagnetic interferences, which can stem in particular from the motor lines 29, 30, 31.

As an example, the invention is presented using the example of a cooking equipment or a cleaning apparatus for the cooking equipment, respectively. The cleaning apparatus can be realized similarly for other kitchen equipment, in particular for combination steamers, baking equipment or similar oven systems. The kitchen equipment can be designed as commercially used kitchen equipment or as household kitchen equipment.

Both embodiments of the invention provide a sensor 32 for acquiring a value for the amount of liquid at the collecting tank 2. The sensor 32 can be designed according to a kind of pressure sensor, for example. The sensor 32 can communicate with the central control unit 10, for example via the already provided data bus 23. Providing the pressure sensor 32 is optional. For example, a temperature sensor or a sensor for determining the degree of contamination of the liquid sitting in the collecting tank 2 can be provided.

Furthermore, an inlet line 33 connected to a not shown water reservoir can be provided at the collecting tank 2 and can be used to supply, for example, fresh water or a cleaning fluid to the collecting tank 2. A valve 34 can he provided at the supply line 33 for selective closing or opening thereof. Optionally, the supply line 33 can be connected to the cooking space 1 such that the fresh water can be supplied directly into the cooking space 1 via the supply line 33. Without alterations, the valve 34 can be provided to influence an amount of fresh water that is supplied via the supply line 33.

An overflow 35 can be provided in the area of the collecting tank 2 and can be used to supply the liquid sitting in the collecting tank 2 directly to the drain line 6 as soon as a maximum permissible liquid level is exceeded in the collecting tank 2. Furthermore, a drain 36 can be provided for the liquid that is to be removed from the cooking space 1 and can be used for at least part of the liquid to arrive directly in the drain line 6 by bypassing the collecting tank 2. Such a drain is realized, for example, in the area of a door 37 of the kitchen equipment.

According to an alternative, embodiment of the invention (not shown), the inverted rectifier 24 for motor 8 is provided directly at the drive motor 8, while the inverted rectifiers 25, 26 for the pump motors 13, 19 are arranged together with the supply unit 27 at a distance from the motors 13, 19.

There has thus been shown and described a novel control unit for a cooking device which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Cleaning apparatus for a kitchen cooking device having a cooking space to be cleaned, which is delimited by at least one wall, and having at least one outlet opening for a liquid, said apparatus comprising, in combination:
a ventilation fan associated with the cooking space and a drive motor for the ventilation fan;
a collecting tank that takes up and collects at least temporarily the liquid that exits the cooking space via the outlet opening;
a supply line that can be connected to a water reservoir and selectively opened and closed to the supply liquid;
a circulating pump for pumping liquid and comprising a circulating pump wheel and a circulating pump motor that drives the circulating pump wheel;
a circulation line by which the liquid pumped by the circulating pump can be transported to the cooking space;
a drain line connected to the collecting tank for removing the liquid obtained from the collecting tank; and
a control unit for operating the drive motor and the circulating pump motor;
wherein the control unit comprises a distributed power electronics having a first inverted rectifier for the drive motor of the ventilation fan and a second inverted rectifier for the circulating pump motor, and having a supply unit, connectable to a power source, that is provided jointly for the inverted rectifiers and comprises a rectifier, an interim circuit and a power factor correction filter.

2. Cleaning apparatus as in claim 1, further comprising a drain pump having a drain pump wheel and a drain pump motor that drives the drain pump wheel for pumping away the liquid that exits the cooking space via the drain line; and wherein the power electronics include a third inverted rectifier for the drain pump motor which interacts with the joint supply unit to operate the drain pump motor.

3. Cleaning apparatus as in claim 1, wherein at least one of the inverted rectifiers fed by the joint supply unit is arranged adjacent to the respective associated motor which it powers.

4. Cleaning apparatus as in claim 1, further comprising a central control unit that interacts with the inverted rectifiers of the distributed power electronics to control the motors.

5. Cleaning apparatus as in claim 4, wherein the central control unit and the inverted rectifiers of the distributed power electronics are connected via a data bus.

6. Cleaning apparatus as in claim 2, wherein the circulating pump and the drain pump are associated with the collecting tank such that the liquid sitting in the collecting tank can be supplied to the cooking space using the circulating pump and can be pumped off into the drain line using the drain pump.

7. Cleaning apparatus as in 2, wherein at least one of the drive motor for the ventilation fan, the circulating pump motor and the drain pump motor are selected from the group consisting of brushless DC motors and synchronous motors.

8. Cleaning apparatus as in claim 3, wherein at least one of the inverted rectifiers is mounted directly on a bearing shield of the associated motor.

9. A distributed power electronics in a cleaning apparatus for kitchen equipment, including a joint supply unit connectable to a power source and having a rectifier, an interim circuit and a power factor correction filter as well as a plurality of inverted rectifiers for controlling a plurality of drive motors, wherein a first inverted rectifier is used to control a drive motor of a ventilation fan provided in the kitchen equipment; a second inverted rectifier is used to control a first pump motor of the cleaning apparatus for pumping a liquid; and a third inverted rectifier is used to control a second pump motor of the cleaning apparatus.

10. the distributed power electronics of claim 9, wherein the third inverted rectifier is used to control a, drain pump motor for pumping liquid from the kitchen equipment.
